(19) United States
(12) Patent Application Publication
(10) Pub. No.: US 2006/0025171 A1
(43) Pub. Date: Feb. 2, 2006

(54) Information handling system capable of switching among multiple wireless radio architectures

(75) Inventors: Liem Ly, Fort Worth, TX (US); Pratik M. Mehta, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/899,916

(22) Filed: Jul. 27, 2004

(51) Int. Cl. H04B 7/00; H04B 1/06

(52) U.S. Cl. 455/553.1; 455/552.1; 455/426.1

(57) ABSTRACT

An information handling system (IHS) is provided which includes multiple radios having different architectures. The IHS also includes multiple antennas. A selected one of the radios is given priority over other of the radios to be connected to an appropriate one of the multiple antennas. The disclosed system desirably reduces the number of switches required to couple the antennas to the radios.

### BACKGROUND

The disclosures herein relate generally to information handling systems (IHS's) and more particularly to information handling systems including multiple radios therein.

As the value and use of information continue to increase, individuals and businesses seek additional ways to process and store information. One option available to users is information handling systems. An information handling system (IHS) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Today's IHS's may include multiple radios operating on respective standards, for example IEEE 802.11A, IEEE 802.11B, IEEE 802.11G and the Bluetooth radio standard. IEEE 802.11A, IEEE 802.11B, IEEE 802.11G radios are radios of like architecture, whereas Bluetooth radios and IEEE 802.11A/B/G radios are radios of different architecture. One way to build an IHS with multiple radio architectures is to provide a dedicated antenna for each radio in the IHS. Unfortunately with this approach the number of antennas increases along with the number of different radios in the IHS such that a large number of antennas may be required. Plug-in wireless cards are available which include multiple radios of like architecture that are coupled to multiple antennas. It is also known to provide 2 antennas per radio and switch between the antennas to provide the best reception. Such a switching arrangement is known as a diversity switching arrangement. Mini PCI cards are available which include like architecture dual band 802.11a and b/g radios which are switched between 2 antennas. Unfortunately, switches are lossy elements and the greater the number of switches employed in a particular switching arrangement, the greater is the loss encountered.

What is needed is an IHS which is capable of switching among multiple antennas and multiple radios in an efficient manner with low loss. Lower total solution cost and more efficient use of board real-estate are also desirable.

### SUMMARY

Accordingly, in one embodiment, a method is disclosed for operating an information handling system (IHS) which includes providing a plurality of antennas to the system. The method also includes sharing the plurality of antennas among a plurality of radios exhibiting different radio architectures. In one embodiment, one of the radios can be given priority over other radios with respect to antenna connection.

In another embodiment, an information handling system (IHS) is disclosed which includes a plurality of antennas. The IHS also includes a plurality of radios exhibiting different radio architectures. The IHS further includes a plurality of switches configured to connect the plurality of radios to the plurality of antennas. In one embodiment of the system, one of the radios can be given priority over other radios with respect to connection to the antennas.

A principal advantage of one or more of the embodiments disclosed herein is that antenna switching among radios of different architectures in the IHS is provided with a minimal number of RF switches. This is very desirable since RF switches contribute to RF loss.

### BRIEF DESCRIPTION OF THE DRAWINGS

FIG. 1 is a high level block diagram of the disclosed information handling system (IHS).

FIG. 2 is a block diagram showing one embodiment of the switching apparatus employed in the disclosed IHS.

FIG. 3 is a block diagram showing another embodiment of the switching apparatus employed in the disclosed IHS.

FIG. 4 is a block diagram showing yet another embodiment of the switching apparatus employed in the disclosed IHS.

FIG. 5 is a block diagram showing still another embodiment of the switching apparatus employed in the disclosed IHS.

### DETAILED DESCRIPTION

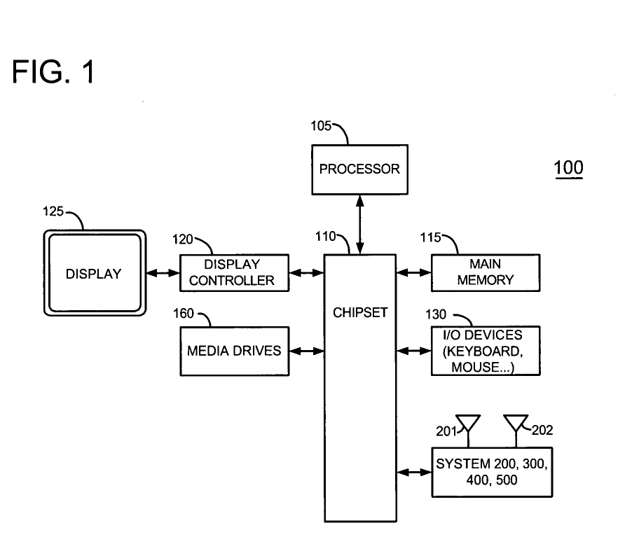

FIG. 1 is a block diagram of the disclosed information handling system (IHS) 100. For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a video display, a keyboard, a mouse, voice inputs and other human interface devices (HIDs). The information handling system may also include one or more buses operable to transmit communications between the various hardware components.

IHS 100 includes a processor 105 such as an Intel Pentium series processor, an Advanced Micro Devices (AMD) processor or one of many other processors currently available. A chipset 110 provides IHS 100 with glue-logic that connects processor 105 to other components of IHS 100. For example, chipset 110 couples processor 105 to main memory 115 and to a display controller 120. A display 125 can be coupled to display controller 120 as shown. Chipset 110 also acts as an I/O controller hub which connects processor 105 to media drives 130 and I/O devices 135 such as a keyboard, mouse, audio circuitry, and peripherals for example.

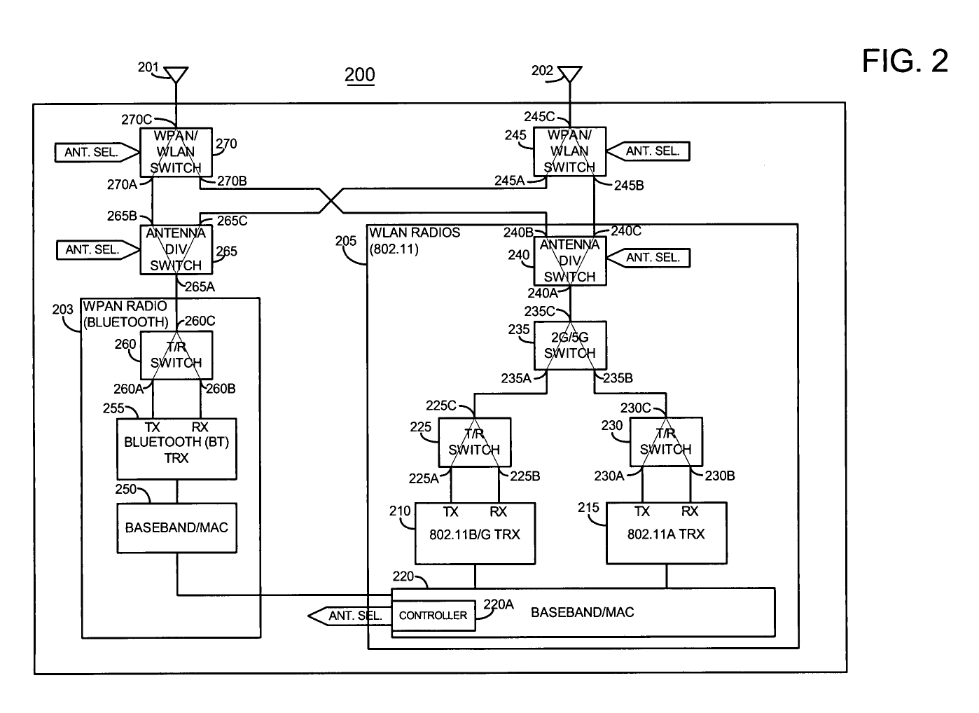

FIG. 2 is a block diagram of a system 200 which switches among multiple different architecture radios and multiple antennas. System 200 is coupled to chipset 110 as shown in FIG. 1, or alternatively, system 200 is coupled to processor 105. Returning to FIG. 2 it is seen that system 200 includes antennas 201 and 202. In this particular embodiment, system 200 includes a wireless personal area network (WPAN) or Bluetooth radio 203 and wireless local area network (WLAN) block 205. WLAN block 205 includes radios exhibiting like radio architectures, namely an IEEE 802.11B/G transceiver (TRX) 210 and an IEEE 802.11A transceiver (TRX) 215. Radios which have the same or substantially similar architectures, such as those complying with related standards such as the various IEEE 802.11 series of standards, are regarded as being like-architected radios. WPAN radio 203, with its Bluetooth technology in this particular example, is regarded as exhibiting a dissimilar radio architecture as compared with WLAN radios 205.

TRX 210 and TRX 215 have a common baseband/media access control (MAC) layer 220 to which they are both coupled. In this particular embodiment, TRX 210 includes two internal like architected radios for the IEEE 802.11B and IEEE 802.11G standards, respectively, both of which transmit and receive in the 2.4 GHz ISM frequency band. TRX's 210 and 215 are said to have like WLAN architectures. TRX 215 transmits and receives in the 5 GHz ISM & U-NII bands associated with the IEEE 802.11 A standard.

Baseband/MAC circuitry 220 processes the information which is to be transmitted and the information which is received by a particular radio in WLAN block 205. Baseband/MAC 220 includes a controller 220A which generates an ANTENNA SELECT (ANT. SEL.) signal that controls switching among the various components of system 200 as described below in more detail. Baseband/MAC circuitry 220 is coupled to Baseband/MAC circuitry 250 of WPAN radio 203 as seen in FIG. 2. However, since in this particular embodiment controller 220A is situated in WLAN radio block 205, the radios in WLAN block 205 can have priority over WPAN radio 203 with respect to the various switching functions described below. It is noted that, in one embodiment, priority can be granted to either radio regardless of the location of controller 220A.

A transmit-receive (T/R) switch 225 includes ports 225A and 225B that are coupled to the transmit (TX) and receive (RX) ports of TRX 210 as shown. T/R switch 225 connects port 225A to port 225C when TRX 210 is transmitting and connects port 225B to port 225C when TRX 210 is receiving. Similarly, a transmit-receive (T/R) switch 230 includes ports 230 A and 230 B that are coupled to the transmit (TX) and receive (RX) ports of TRX 215 as shown. T/R switch 230 connects port 230A to port 230C when TRX 215 is transmitting and connects port 230B to port 230C when TRX 215 is receiving. T/R switches employ standard internal logic to determine when they should be switch from transmit to receive and vice versa. T/R switches 225, 230 & 235 are controlled by baseband/MAC circuitry block 220 as to when the switches should switch between transmit/receive and between 2G/5G.

A 2G/5G switch 235 is coupled to T/R switches 225 and 230 as shown. Switch 235 switches between the 2.4 GHz transceiver TRX 210 and the 5 GHz transceiver TRX 215. Switch inputs 235A and 235B are respectively coupled to TR switch outputs 225C and 230C as shown. Switch 235 assures that one of TRX's 210 and 215 are provided output at any particular time. It is desirable that both TRX's not transmit and be provided output at the same time.

An antenna diversity switch 240 includes an input 240a that is coupled to the output 235C of 2G/5G switch 235. Antenna diversity switch 240 is connected to controller 220A so that it can receive and respond to the ANTENNA SELECT signal. Depending on the instruction contained in the ANTENNA SELECT signal, the particular radio selected and currently connected to antenna diversity switch 240 by 2G/5G switch 235 can be coupled to either antenna 201 and antenna 202.

Antenna diversity switch 240 operates in conjunction with WPAN/WLAN switch 245 which is also coupled to controller 220A to receive the ANTENNA SELECT control signal. WPAN radio 203 is now described. In this particular embodiment, radio 203 is a WPAN radio exhibiting a different architecture than WLAN radios 205. For example, one radio architecture that may be used for WPAN radio 203 is the Bluetooth radio architecture. WPAN radio 203 includes a Bluetooth transceiver TRX 255 which is coupled to baseband/MAC circuitry 250. Bluetooth transceiver TRX 255 includes transmit (TX) and receive (RX) ports which are coupled to respective inputs 260A and 260B of T/R switch 260. When Bluetooth TRX 255 is transmitting, port 260A is coupled to output 260C to provide output to the transmit signal, whereas when Bluetooth TRX 255 is in receive mode, port 260B is coupled to output 260C.

An antenna diversity switch input 265A is coupled to the output 260C of T/R switch 260 as shown. Antenna diversity switch outputs 265B and 265C are coupled to antennas 201 and 202 via WPAN/WLAN switches 270 and 245, respectively. WPAN/WLAN switch 270 and antenna diversity switch 265 are coupled to controller 220 to receive the ANTENNA SELECT signal that controls the switching state of these switches. It will be recalled that the ANTENNA SELECT signal is also supplied to the WPAN/WLAN switch 245 and antenna diversity switch 240 as shown. In this manner, by sending an appropriate ANTENNA SELECT command to switches 240, 245, 265 and 270, controller 220 can control whether one of WLAN radios 205 or WPAN radio 203 is selected and to determine whether antenna 201 or antenna 202 is coupled to the radio thus selected.

The disclosed system topology permits several combinations of radios and antennas wherein WPAN radio 203 or one of WLAN radios 205 can be connected to one of antennas 201 and 202. The ANTENNA SELECT signal generated by controller 220A in baseband/MAC 220 instructs switches 240, 245, 265 and 270 to connect a particular radio to a particular antenna according to the connections specified in TABLE 1 below. In this particular embodiment, the ANTENNA SELECT signal is a single bit signal which is either 1 or 0. Other embodiments are possible wherein the ANTENNA SELECT signal has a plurality of bits or other coding to control the above discussed switches to connect particular radios to particular antennas.

When controller 220 generates an ANTENNA SELECT signal that is a logic “1” or a logic “0”, then switches 245, 240, 270 and 265 form connections between the radios and the antennas as specified in TABLE 1 below.

TABLE 1

| | ANTENNA | ANTENNA |
|---|---|---|
| | SELECT = 1 | SELECT = 0 |
| WPAN/WLAN switch 245 | 245C to 245B | 245C to 245A |
| Antenna div. switch 240 | 240C to 240A | 240B to 240A |
| WPAN/WLAN switch 270 | 270C to 270A | 270C to 270B |
| Antenna div. switch 265 | 265B to 265A | 265C to 265A |

Each of the switches employed in system 200 is a radio frequency (RF) switches. RF switches have a certain amount of loss associated with them. Thus, it is generally desirable to have a low number of RF switches in a switching arrangement. TABLE 2 below illustrates the number of switches associated with the various radios in system 200. In other words, TABLE 2 shows the number of RF switches between a particular radio and an antenna.

TABLE 2

| Radio Description | Number of Associated RF Switches |
|---|---|
| WPAN (Bluetooth) | 3 |
| WLAN (802.11A) | 4 |
| WLAN (802.11B/G) | 4 |

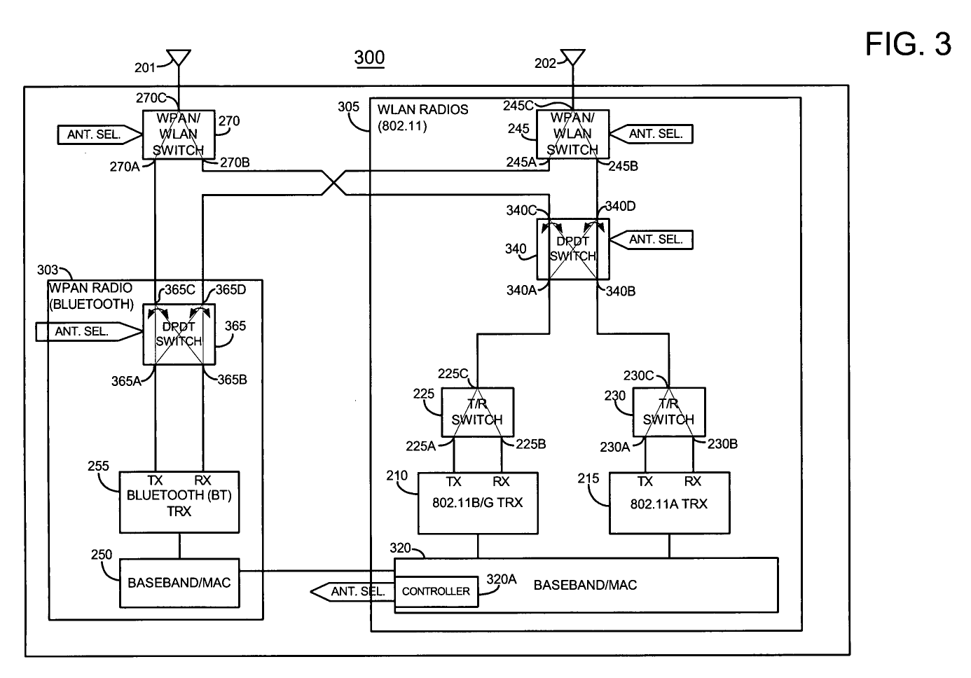

FIG. 3 is an alternative embodiment of the system, namely a system 300 that includes a reduced number of RF switches as compared with system 200 of FIG. 2. In comparing system 300 and 200, like numbers are used to indicate like elements. The functionality of antenna diversity switch 240 and 2G/5G switch 235 of FIG. 2 have been incorporated in a single double pole, double throw (DPDT) switch 340 in FIG. 3. The ANTENNA SELECT signal from bandband/MAC controller 320A is fed to DPDT switch 340 as shown to control which of radios 210 and 215 are coupled to one of antennas 201 and 202 selected by the switch. The WLAN radio block 305 includes switches 245, 340, 225 and 230 as well as transceivers TRX 210 and 215 and baseband/MAC 320 all as shown in FIG. 3.

The functionality of antenna diversity switch 265 and TR switch 260 of FIG. 2 have been incorporated in a single double pole, double throw switch 365 in WPAN radio 303 of FIG. 3. The ANTENNA SELECT signal from bandband/MAC controller 320A is fed to DPDT switch 365 as shown to control which of antennas 201 and 202 is connected to Bluetooth radio 255. WPAN radio block 303 includes DPDT switch 365, radio 255 and baseband/MAC 250.

When controller 320A generates an ANTENNA SELECT signal that is a logic “1”, or a logic “0”, then switches 245, 340, 270 and 365 form connections between the radios and the antennas as specified in TABLE 3 below.

TABLE 3

| | ANTENNA | ANTENNA |
|---|---|---|
| | SELECT = 1 | SELECT = 0 |
| WPAN/WLAN switch 245 | 245C to 245B | 245C to 245A |
| DPDT switch 340 | 340B to 340A | 340C to 340B |
| | 340D to 340B | 340D to 340A |
| WPAN/WLAN switch 270 | 270C to 270A | 270C to 270B |
| DPDT switch 365 | 365C to 365A | 365D to 365A |
| | 365D to 365B | 365B to 365C |

TABLE 4 below illustrates the number of switches associated with the various radios in system 300.

TABLE 4

| Radio Description | Number of Associated RF Switches |
|---|---|
| WPAN (Bluetooth) | 2 |
| WLAN (802.11A) | 3 |
| WLAN (802.11B/G) | 3 |

In this embodiment, the ANTENNA SELECT signal is controlled by controller 320A to select one of antennas 201 and 202 with the best receive performance for the radio currently being used. In one embodiment, an ANTENNA SELECT signal is generated that causes the WPAN radio to use the antenna not selected for the WLAN radio. It is noted that in this embodiment, WPAN radio 255 experiences a decreased amount of signal loss because its signals go through a reduced number of RF switches, namely 2 RF switches instead of 3 or more. Priority can be granted to either radio 303 or 305 for antenna selection in this embodiment.

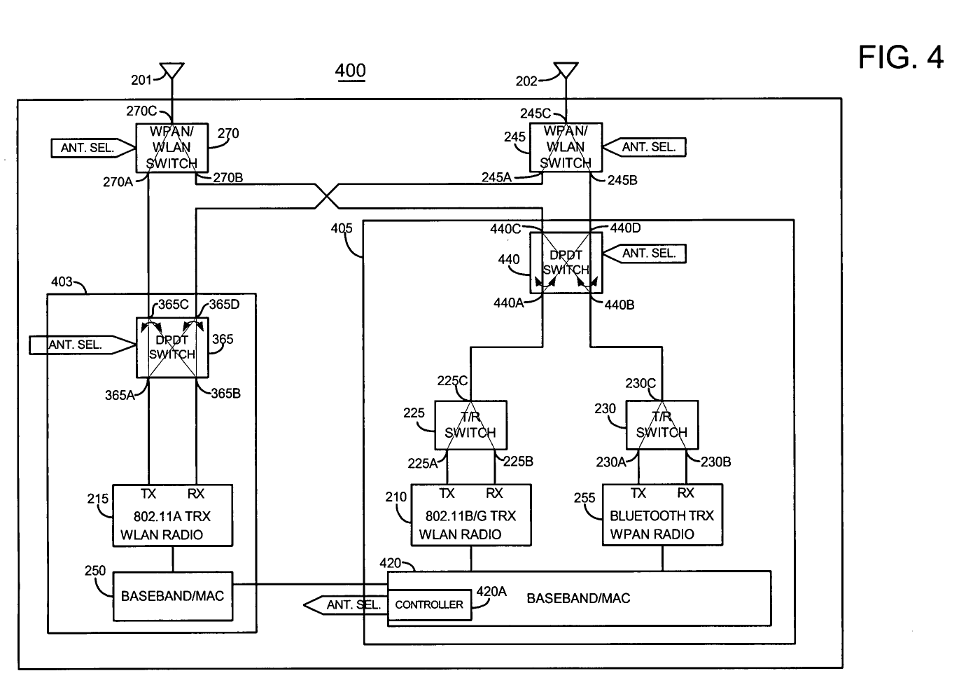

FIG. 4 is another alternative embodiment of the system, namely a system 400 that includes a reduced number of RF switches. System 400 and system 300 are similar except that in system 400, the WPAN radio 255 and the WLAN 802.11A radio 215 change locations with one another and DPDT switch 440 is reconfigured as shown. In comparing system 400 and 300, like numbers are used to indicate like elements. Block 405 includes DPDT switch 440, T/R switches 225 and 230, transceivers TRX 210 and 255 and baseband/MAC 420. Block 403 includes DPDT switch 365, transceiver TRX 215 and baseband/MAC 250.

The ANTENNA SELECT signal from bandband/MAC controller 420A is fed to DPDT switch 440 as shown to control which of radios 210 and 255 is coupled to one of antennas 201 and 202 selected by that switch.

When controller 420A generates an ANTENNA SELECT signal that is a logic “1”, or a logic “0”, then switches 245, 440, 270 and 365 form connections between the radios and the antennas as specified in TABLE 5 below.

TABLE 5

| | ANTENNA | ANTENNA |
|---|---|---|
| | SELECT = 1 | SELECT = 0 |
| WPAN/WLAN switch 245 | 245C to 245B | 245C to 245A |
| DPDT switch 440 | 440D to 440B | 440C to 440B |
| | 440C to 440A | 440D to 440A |
| WPAN/WLAN switch 270 | 270C to 270A | 270C to 270B |
| DPDT switch 365 | 365C to 365A | 365D to 365A |
| | 365D to 365B | 365B to 365C |

TABLE 6 below illustrates the number of switches associated with the various radios in system 400.

TABLE 6

| Radio Description | Number of Associated RF Switches |
|---|---|
| WPAN (Bluetooth) | 3 |
| WLAN (802.11A) | 2 |
| WLAN (802.11B/G) | 3 |

It is noted that controller 420A can physically reside either in baseband/MAC circuitry 420, as illustrated, or in baseband/MAC 250 circuitry. For the purpose of FIG. 3, the WLAN 802.11a radio is given priority to select the antenna with the best signal strength. In this embodiment, the ANTENNA SELECT signal is controlled by controller 420A to select one of antennas 201 and 202 with the best receive performance for the 802.11A radio currently being used. An ANTENNA SELECT signal is generated that causes the switching and connections depicted in TABLE 5 above. This results in the WPAN radio 255 always using the antenna not selected for WLAN radio 802.11A. It is noted that WLAN radio 802.11A, namely TRX 215, now is subjected to fewer switches, namely 2, and less loss than in system 300 of FIG. 3.

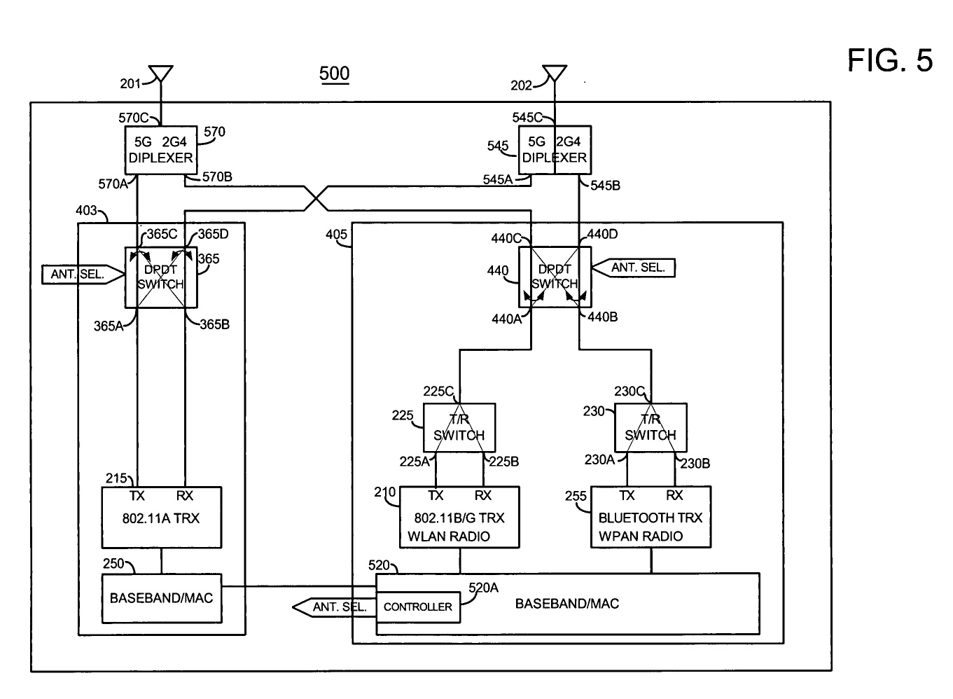

FIG. 5 is yet another alternative embodiment of the system, namely a system 500 that includes a further reduced number of RF switches. System 500 and system 400 are similar except that in system 500, WPAN/WLAN switches 245 and 270 are replaced with 5G/2G diplexers 545 and 570. In comparing system 500 and 400, like numbers are used to indicate like elements While a diplexer adds more RF loss than an RF switch, the diplexers employed in this embodiment permit higher isolation between the dual band radios than if switches were employed. In this embodiment, the ANTENNA SELECT signal is controlled by WLAN radio 802.11A, namely TRX 215, to select the antenna with the best receive performance. Controller 520A can physically reside either in baseband/MAC circuitry 520 or baseband/MAC circuitry 250. Therefore, for the purpose of FIG. 5, the WLAN 802.11a radio is given priority to select the antenna with the best signal strength. The ANTENNA SELECT signal controls the state of DPDT switches 365 and 440 to connect the various radios to antennas 201 and 202 as set forth in TABLE 7 below.

TABLE 7

| | ANTENNA | ANTENNA |
|---|---|---|
| | SELECT = 1 | SELECT = 0 |
| DPDT switch 440 | 440D to 440B | 440C to 440B |
| | 440C to 440A | 440D to 440A |
| DPDT switch 365 | 365C to 365A | 365D to 365A |
| | 365D to 365B | 3658 to 365C |

The WPAN TRX 255 uses the antenna not selected for WLAN TRX 215

TABLE 8 below illustrates the number of switches associated with the various radios in system 500.

TABLE 8

| Radio Description | Number of Associated RF Switches |
|---|---|
| WPAN (Bluetooth) | 2 |
| WLAN (802.11A) | 1 |
| WLAN (802.11B/G) | 2 |

The disclosed methodology and apparatus provide efficient switching among multiple differently architected radios and antennas with a reduced number of RF switches and reduced loss. The IHS that employs the disclosed technology may take many different forms, for example network infrastructure devices such as a client system, an access point system, a router and a gateway. Other applications are expected as well.

Although illustrative embodiments have been shown and described, a wide range of modification, change and substitution is contemplated in the foregoing disclosure and in some instances, some features of an embodiment may be employed without a corresponding use of other features. Accordingly, it is appropriate that the appended claims be construed broadly and in manner consistent with the scope of the embodiments disclosed herein.

What is claimed is:

1. A method of operating an information handling system (IHS) comprising:
providing a plurality of antennas, and
sharing the plurality of antennas among a plurality of radios exhibiting different radio architectures.

2. The method of claim 1 wherein the radio architectures include WLAN and WPAN.

3. The method of claim 1 wherein the method is implemented in a client system.

4. The method of claim 1 wherein the method is implemented in an access point system.

5. The method of claim 1 wherein the method is implemented in a router.

6. The method of claim 1 wherein the method is implemented in a gateway.

7. The method of claim 1 wherein the plurality of radios is greater than 2.

8. The method of claim 1 wherein the plurality of antennas includes 2 antennas.

9. The method of claim 1 including generating an antenna select signal by a controller to control which of the plurality of antennas are coupled to which of the plurality of radios exhibiting different radio architectures.

10. The method of claim 9 including generating the antenna select signal by a controller which gives priority to one of the plurality of radios with respecting to connecting that radio to an antenna.

11. An information handling system (IHS) comprising:
a plurality of antennas;
a plurality of radios exhibiting different radio architectures; and
a plurality of switches configured to connect the plurality of radios to the plurality of antennas.

12. The IHS of claim 11 wherein the radio architectures include WLAN and WPAN.

13. The IHS of claim 11 wherein the IHS is a client system.

14. The IHS of claim 11 wherein the IHS is an access point system.

15. The IHS of claim 11 wherein the IHS is a router.

16. The IHS of claim 11 wherein the IHS is a gateway.

17. The IHS of claim 11 wherein the plurality of radios is greater than 2.

18. The IHS of claim 11 wherein the plurality of antennas comprises 2 antennas.

19. The IHS of claim 11 including a controller, coupled to the plurality of switches, that generates an antenna select signal to control which of the plurality of antennas are coupled to which of the plurality of radios exhibiting different radio architectures.

20. The IHS of claim 19 wherein one of the plurality of radios is given priority over other of the plurality of radios to be connected to the plurality of antennas.
